(19) United States
(12) Patent Application Publication
(10) Pub. No.: US 2007/0045908 A1
(43) Pub. Date: Mar. 1, 2007

(54) Sugar used during creation of ceramic articles

(76) Inventor: Kathleen Baker, Colorado Springs, CO (US)

Correspondence Address: HANES & SCHUTZ, LLC, 102 SOUTH TEJON ST., SUITE 800, COLORADO SPRINGS, CO, 80903, US

(21) Appl. No.: 11/209,087

(22) Filed: Aug. 23, 2005

(51) Int. Cl. C04B 33/34

(52) U.S. Cl. 264/600

(57) ABSTRACT

A ceramic article is formed from sugar, water, and a clay compound. The sugar, water, and a clay compound are combined to form a mixture. The mixture is shaped into an article. The article is fired.

### BACKGROUND OF THE INVENTION

Ceramic articles are very useful and take many forms. Examples of these forms include tiles and vessels or containers. Forming article of ceramic is easily and economically achieved. However, the use of ceramic articles is limited by its strength and durability. Ceramic is often brittle and easily broken by a strong impact. Providing a stronger ceramic article would significantly broaden the types of application for which ceramics may be used.

### DESCRIPTION OF THE DRAWINGS

FIG. 1 is a flow chart illustrating one embodiment of the present invention process for marking ceramic articles.

FIG. 2 is a flow chart illustrating an alternate embodiment of the present invention process for marking ceramic articles.

FIG. 3 is a flow cart illustrating one embodiment for making the sugar water of FIG. 2.

FIG. 4 is a cross-sectional diagram illustrating one embodiment of multiple articles according to the present invention, packed in a metal drum and cushioned with padding.

### DETAILED DESCRIPTION OF THE INVENTION

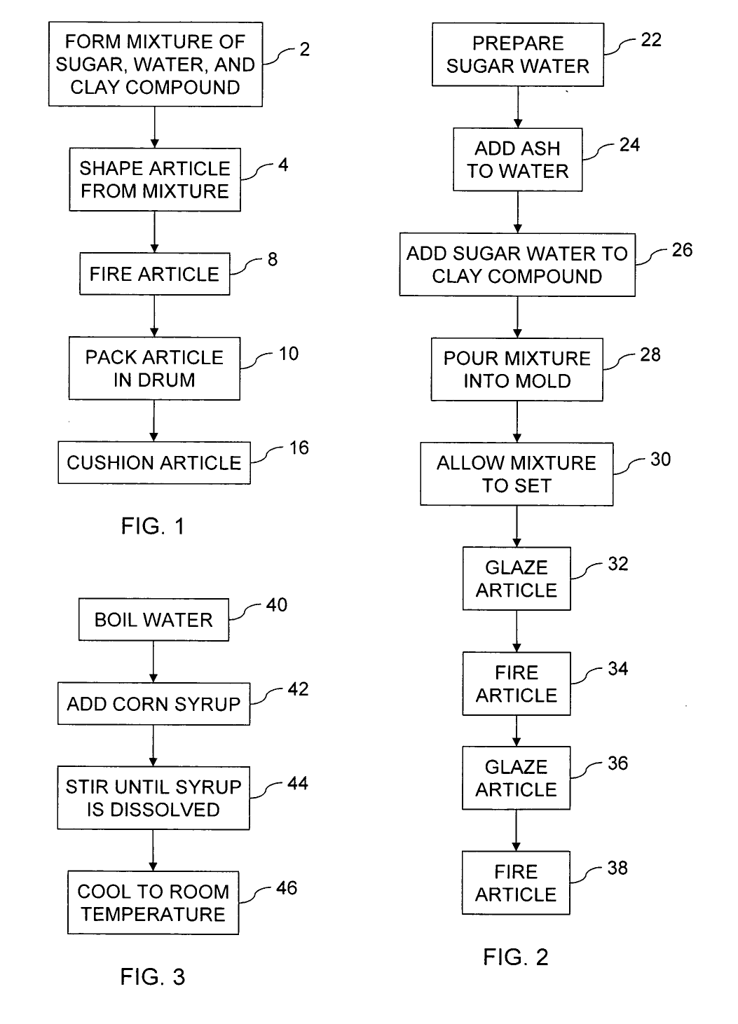

FIG. 1 is a flow chart representing steps of one embodiment of a method for producing a ceramic article. Although the steps represented in FIG. 1 are presented in a specific order, the disclosed subject matter encompasses variations in the order of steps. Furthermore, additional steps may be executed between the steps illustrated in FIG. 1 without departing from the scope of the claimed subject matter.

A mixture of sugar, water, and a clay compound is formed 2. In one embodiment, the sugar is introduced into the clay mixture using sugar water mixed with a dry clay compound. In one embodiment, the mixture is thoroughly mixed with a paint mixing paddle so that it is very smooth and with a consistency of cake batter. In one embodiment, the mixture is mixed so that air is allowed to escape.

In one embodiment, the sugar and water are first mixed together to produce the sugar water before adding it to the clay compound. In alternate embodiments, the sugar may be introduced into the clay mixture in any convenient, desirable, or necessary manner. The sugar, the water, and the clay compound are mixed in any order to form the mixture.

In one embodiment, the sugar includes a liquid sugar, such as corn syrup. In alternative embodiments, the sugar is any combination of sugars.

In one embodiment, the clay compound is a mixture of china clay, feldspar, New York slip, and corundum, for example, 45% china clay, 30% feldspar, 10% New York slip, and 15% corundum. The clay compound is thoroughly mixed. In one embodiment, the china clay is Kentucky-Tennessee ball clay. Additionally, in one embodiment, the feldspar is fine feldspar. In a further embodiment, the corundum is of the regular type and not medical strength

In another embodiment, the clay compound further includes sodium silicate. In another embodiment, the clay compound further includes soda ash or another deflocculant. Each of these two components may be mixed in at a quantity of about 0.2%. In one embodiment, the soda ash is first vacuumed in a chamber and the moisture removed from it. In a further embodiment, the sodium silicate is dried with nitrate at 3 pounds pressure to drain it so that it mixes well.

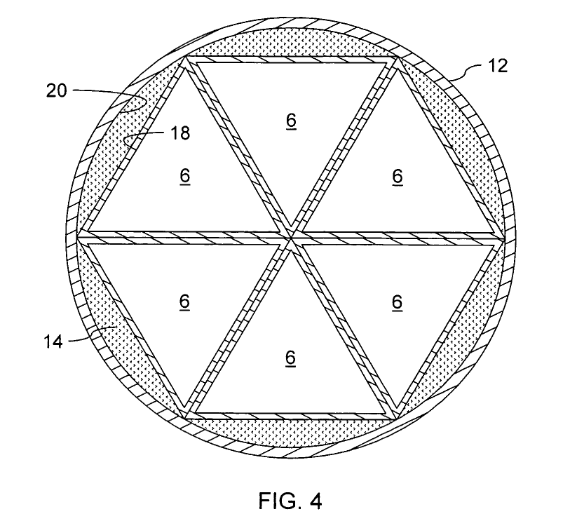

The mixture is shaped 4 into an article 6 (FIG. 4). In one embodiment, the article 6 is shaped 4 by pouring it into a mold and allowing it to dry. Alternatively, the article 6 is shaped 4 by any procedure designed to produce the desired shape in the article 6.

The article 6 is fired 8. In one embodiment, the article 6 is fired 8 in a gas kiln. In an alternative embodiment, the article 6 is fired 8 in an electric kiln.

In one embodiment, the article 6 is packed 10 into a metal drum 12 (Fig. 4). Cushioning material, or insulation, 14 (FIG. 4) is provided 16 between the exterior 18 (FIG. 4) of the article 6 and the interior 20 (FIG. 4) of the drum 12.

FIG. 2 is a flow chart representing steps of another embodiment of a method for producing a ceramic article. Although the steps represented in FIG. 2 are presented in a specific order, the disclosed subject matter encompasses variations in the order of steps. Furthermore, additional steps may be executed between the steps illustrated in FIG. 2 without departing from the scope of the claimed subject matter.

Sugar water is prepared 22 from the sugar and the water. In one embodiment, soda ash is added 24 to the sugar water.

The sugar water is added 26 to the clay compound to form the mixture. In one embodiment, the sugar water is added 26 to 80 pounds of the dry clay compound. In one embodiment, the sugar water is 68 degrees Fahrenheit when added. The sugar water is added 26 as necessary to obtain the desired consistency. The dry and wet ingredients are mixed until thoroughly combined.

The mixture of the sugar, the water, and the clay compound is poured 28 into a mold (not shown). In one embodiment, a plastic mold is first prepared for casting by lightly spreading a petroleum jelly, such as Vaseline®, around the entire inner surface and around the top portion of the mold. The mold is then dusted with talcum powder.

The mixture is allowed 30 to at least partially dry in the mold so that its shape is set before it is removed from the mold. The at least partially dried mixture is now in the shape of the article 6. In one embodiment, the ceramic mixture is allowed to set within the mold for 6 to 8 hours, with fans blowing at the sides of the mold until the mold has set one inch from the outside of the rim. When the mixture has formed and is set within one inch within the mold, any remaining mixture is poured off. The remaining mixture in the mold is allowed to set until firm enough to hold its shape and be removed without damage to the article 6.

If not completely dried when removed from the mold, the article 6 may be allowed to continue drying until the desired moisture content is achieved. The desired moisture content is determined using ceramic technology techniques.

In one embodiment, the article 6 is glazed 32 when it is finished drying. Glazing the article 6 decreases its porosity. In one embodiment, the article 6 is dipped in a clear glaze and coated with enough glaze just to cover the article 6 inside and out with a thin coating. The glaze is allowed to completely dry.

The article 6 is then fired 34. In one embodiment, the article 6 is fired in a gas kiln at 1300 degrees Celsius. Alternatively, other types of kilns and other temperatures may be used, as necessary or desirable for the types of clay and glaze.

In one embodiment, the article 6 is again glazed 36 and fired 38. In one embodiment, when the article 6 has completed the first firing and cooled completely, it is again dipped in glaze in the same manner as before. After this thin second glaze is applied, the article 6 is again fired 38 at the desired temperature for the glaze used. In one embodiment, for this second glazing process, an electric kiln is used. Alternatively, other types of kilns may be used.

FIG. 3 is a flow chart representing steps of one embodiment of a method for preparing the sugar water of FIG. 2. Although the steps represented in FIG. 3 are presented in a specific order, the disclosed subject matter encompasses variations in the order of steps. Furthermore, additional steps may be executed between the steps illustrated in FIG. 3 without departing from the scope of the claimed subject matter.

The water is boiled 40 or heated to about 212 degrees Fahrenheit. Corn syrup is added 42 to the water. In one embodiment, one cup of liquid white corn syrup is added to between ten cups and three gallons of heated water. In alternate embodiments, the sugar water is prepared in any manner which generates appropriate or desired ratios of sugar and water.

The water and corn syrup are stirred 44 until the corn syrup dissolves or is absorbed. In one embodiment, the sugar water is allowed to cool 46 to room temperature.

According to the present invention, sugar is introduced into a ceramic clay mixture. Articles made from a clay mixture with sugar have different properties than articles made from the same clay mixture without the sugar. Examples of these different properties include higher strength and lower porosity. Sugar can be added to many various types and combinations of clays to alter the properties of the clays.

Sugar is a natural organic material which negates salts. When sugar is mixed with water and clay, articles produces from the mixture have superior crystal strength.

Sugar creates a semi-permeable membrane within the clay mixture. The semi-permeable membrane restricts the transport of salts and other solutes. The membrane can provide a high surface area material where chemical reactions or diffusion can take place.

Any size or shape of article 6 may be produced using this process. This process is particularly useful for producing low porosity articles. FIG. 4 illustrates one embodiment of a use to which the articles 6 of the present invention may be applied.

Several articles 6 are shaped into elongated triangular shaped vessels. The vessels are aligned together inside a metal drum 12. Packing material 14, such as Styrofoam®, is inserted between the exterior 18 of the article 6 and the interior 20 of the drum 12.

When configured in this way, the vessels 6 are able to contain a variety of hazardous wastes while resisting leakage. The resulting arrangement is also quite durable and resistant to breakage.

The foregoing description is only illustrative of the invention. Various alternatives, modifications, and variances can be devised by those skilled in the art without departing from the invention. Accordingly, the present invention embraces all such alternatives, modifications, and variances that fall within the scope of the described invention.

What is claimed is:

1. A method for producing a ceramic article, the method comprising:
forming a mixture of sugar, water, and a clay compound;
shaping the article from the mixture; and
firing the article.

2. The method of claim 1 wherein forming the mixture includes
preparing sugar water from the sugar and the water and
adding the sugar water to the clay compound to form the mixture.

3. The method of claim 2 wherein preparing the sugar water includes
heating the water and
dissolving the sugar in the heated water.

4. The method of claim 3 further including allowing the heated water with the dissolved sugar to cool before adding it to the clay compound.

5. The method of claim 1 wherein the clay compound is a mixture of china clay, feldspar, New York slip, and corundum.

6. The method of claim 5 wherein the clay compound further includes sodium silicate.

7. The method of claim 5 wherein the clay compound further includes soda ash.

8. The method of claim 2 further including adding soda ash to the sugar water.

9. The method of claim 1 wherein the sugar includes liquid sugar.

10. The method of claim 1 wherein shaping the article includes:
pouring the mixture into a mold and
allowing the mixture to at least partially dry in the mold.

11. The method of claim 1 further including glazing the article before it is fired.

12. The method of claim 1 further including:
glazing the article after it is fired and
firing the article again.

13. The method of claim 1 wherein shaping the article includes shaping the article into a vessel and further including:
packing the vessel into a metal drum and
providing cushioning material between the exterior of the vessel and the interior of the drum.
